(19) United States
(12) Patent Application Publication
(10) Pub. No.: US 2010/0253632 A1
(43) Pub. Date: Oct. 7, 2010

(54) INPUT MODULE HAVING PIEZOELECTRIC PAD

(76) Inventors: Kuan-Yu Chen, Taipei Hsien (TW); Meng-Chou Lee, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/436,787

(22) Filed: May 7, 2009

(30) Foreign Application Priority Data
Apr. 6, 2009 (TW) 098205518

(51) Int. Cl. G06F 3/02; H02N 2/18

(52) U.S. Cl. 345/169; 310/339

(57) ABSTRACT

One or more piezoelectric pads are disposed into a keyboard and electrically connecting to a rechargeable battery of an electronic device or a portable electronic device. When one button of the keyboard is pressed, the movement of the button pushes and deforms the corresponding piezoelectric pad to generate a piezoelectric voltage for charging the battery. The electronic device or the portable electronic device can deal with power shortage during usage with the feature of transforming mechanical power into electrical power by using piezoelectric pads in the keyboard.

### BACKGROUND OF THE INVENTION

1. Field of the Invention

The present invention relates to an input module, and more specifically, to an input module having a piezoelectric pad that can deform to convert mechanical power into electrical power.

2. Description of the Prior Art

Portable electronic devices, such as notebooks, personal digital assistants (PDA), mobile communications devices, etc., are highly noted for the trend of miniaturization, usability, and functionality, accompanying a rising challenging task of power supply for the device. High capacity, rechargeable, memory-less lithium-ion batteries have been the mainstream of the power source for such portable electronic devices though, power shortage still happens in use of the portable electronic devices constantly. On the other hand, for most electronic devices that equip with an input device, the high frequency of clicking or pressing the buttons on the input device only produces the input signals, as is designed for, meaning waste of such huge amount of mechanical power provided by the user. As a result, if the mechanical power of clicking or pressing the buttons can be further utilized to generate electrical power for supplying the electronic device, it can be a timely help for power shortage of the device, with a notable feature of using the mechanical power more efficiently.

### SUMMARY OF THE INVENTION

The present invention is about an input module. The input module includes a button, an input circuit board, a piezoelectric pad, and a power storage device. The piezoelectric pad is disposed between the button and the input circuit board wherein a piezoelectric voltage is generated when the piezoelectric pad is deformed by the button moving toward the input circuit board. The power storage device electrically connects to the piezoelectric pad.

The present invention is also related to a portable electronic device. The portable electronic device includes a power storage device for storing and supplying power and an input module electrically connecting to the power storage device. The input module includes a button, an input circuit board, and a piezoelectric pad. The piezoelectric pad is disposed between the button and the input circuit board wherein a piezoelectric voltage is generated when the piezoelectric pad is deformed by the button moving toward the input circuit board. The power storage device electrically connects to the piezoelectric pad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a first embodiment of an input module having piezoelectric pad according to the invention.

FIG. 2 is an enlarged view of the input module.

FIG. 3 is an illustration of the input module in connection to a portable electronic device.

FIG. 4 is an illustration of a second embodiment of the input module.

FIG. 5 is an illustration of an input device of the input module.

FIG. 6 is an illustration of a notebook.

### DETAILED DESCRIPTION

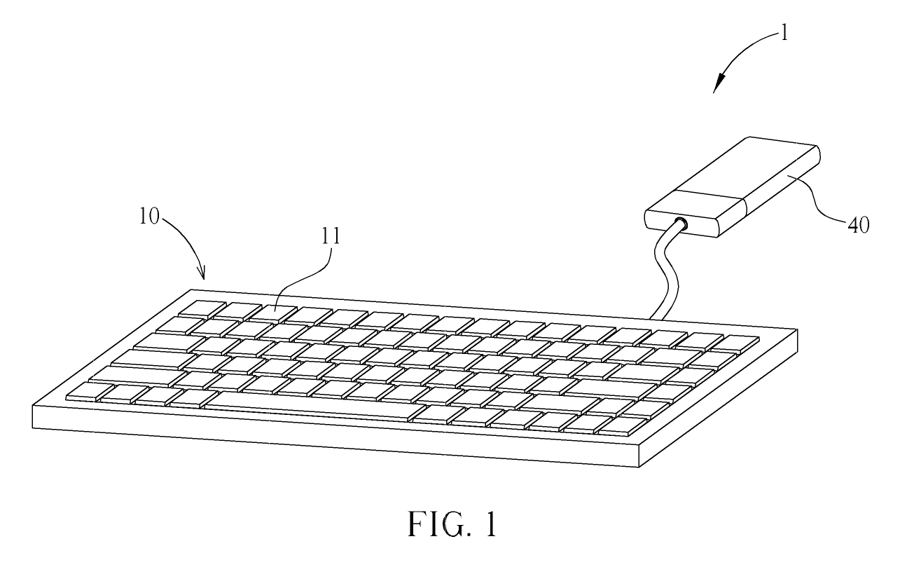

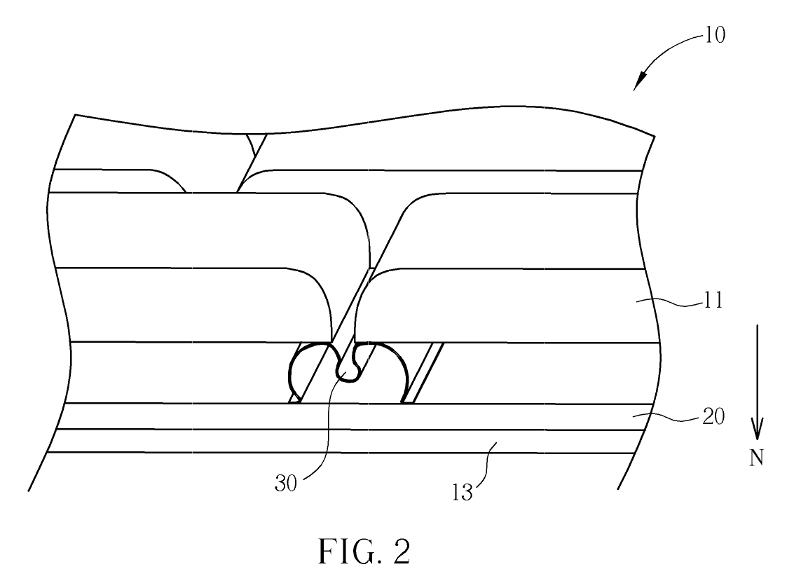

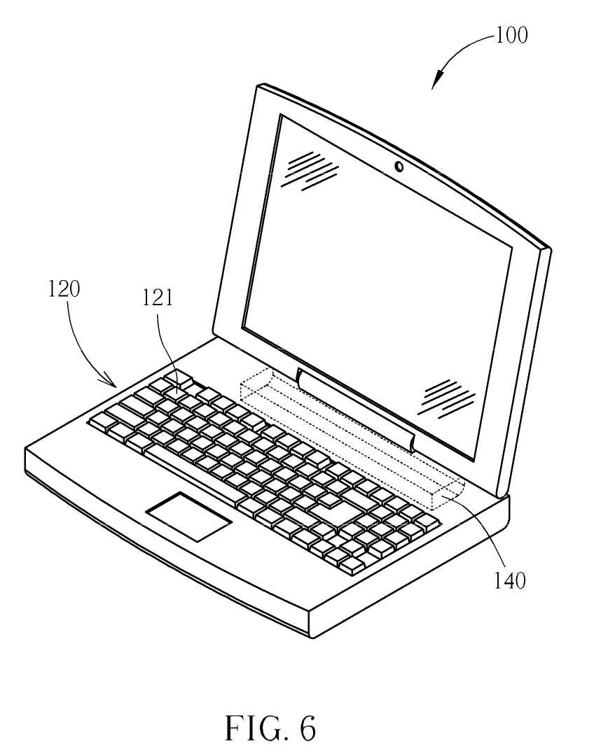

Please refer to FIG. 1 and FIG. 2. FIG. 1 is an illustration of a first embodiment of an input module 1 having piezoelectric pad according to the invention and FIG. 2 is a partially enlarged view of the input module 1. The input module 1 of the embodiment includes an input device 10, a piezoelectric pad 20, and a power storage device 40. Practically, the input module 1 can be a keyboard used in a portable electronic device such as a notebook, a netbook, a mobile phone, or a Smartphone. FIG. 6 shows an illustration of a notebook 100 wherein the keyboard 120 of the notebook 100 is an example of the input device 10 of the input module 1 and the rechargeable lithium battery 140 is an example of the power storage device 40 of the input module 1, while the exemplary piezoelectric pad 20 is disposed beneath the buttons 121 of the keyboard 120 and is invisible in FIG. 6. Except for taking a generic rechargeable battery of the portable electronic device as the power storage device 40, a second power module can also be applied as the power storage device 40 in the portable electronic device for continuity of power supply for the portable electronic device when the power of the generic battery is out. Additionally, the input module 1 disclosed in the embodiment can also be application for other electronic device other than the portable one as mentioned above, by satisfying the need of transforming mechanical power into electrical power for a power storage device.

The input device 10 is, for example, the keyboard itself that includes a plurality of buttons as input component 11. As FIG. 1 and FIG. 2 show, an input circuit board 13 is disposed under the plurality of input components 11 and can be a printed circuit board or thin film with control circuit. As one of the input components 11 moves toward the input circuit board 13 along a certain direction N when pressed by a user, the pressed input component 11 touches a switch at a corresponding location on the input circuit board 13 to generate corresponding electronic signal. Detailed working principle is common knowledge for any person skilled in the art and is omitted herein for brevity. A piezoelectric pad 20 and a contact 30 are disposed between the input components 11 and the input circuit board 13. The piezoelectric pad 20, to be more specific, locates on the path where the input component 11 moves toward the input circuit board 13 along the direction N. The contact 30 is disposed between the input component 11 and the piezoelectric pad 20. The deformation of the piezoelectric pad 20 generates a piezoelectric voltage for charging the battery in the embodiment of the invention. When the user presses the input component 11, the input component 11 moves toward the input circuit board 13 along the direction N and pushes the contact 30 at the same time, which in this embodiment can be an elastic piece made of resilient material for retaining proper pressing texture for the input component 11. The contact 30 then pushes and deforms the piezoelectric pad 20.

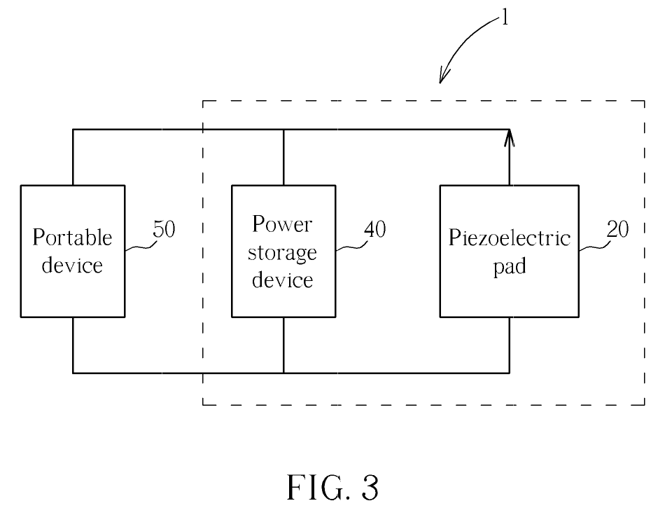

Please refer to FIG. 3, which is an illustration of the input module 1 in connection to a portable electronic device 50. The power storage device 40 is electrically connected to the portable electronic device 50 and supplies power for the portable electronic device 50. The piezoelectric pad 20 of the input module 1 also electrically connects to the power storage device 40. As the aforementioned, when pushed by the input component 11, the piezoelectric pad 20 is deformed and generates the piezoelectric voltage to the power storage device 40, i.e., charges the power storage device 40. As a result, when the portable electronic device 50 has power shortage during consuming the power storage device 40, users can keep pressing on the buttons of the keyboard (generating mechanical power) to continuously deform the piezoelectric pad 20 (transforming the mechanical power into electrical power) in order to charge the power storage device 40, or directly supply power for the portable electronic device 50.

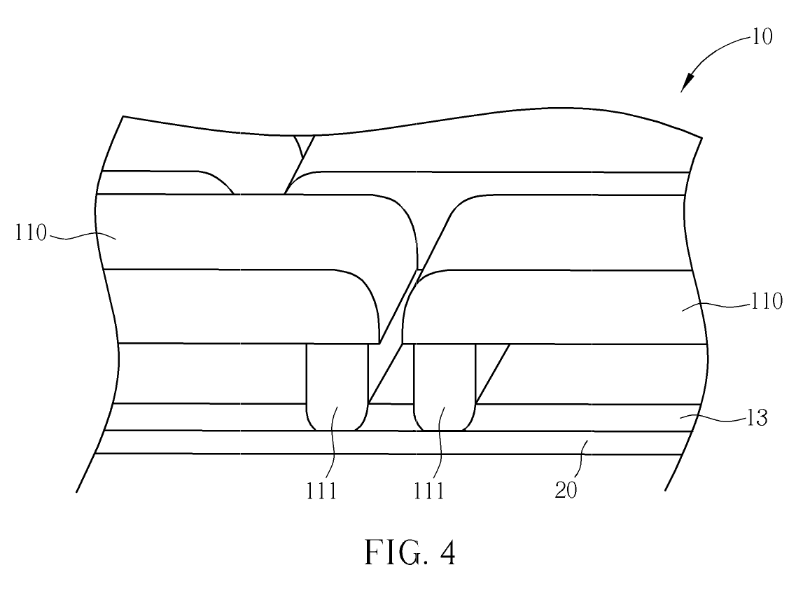

Please refer to FIG. 4. In a second embodiment of the present invention, the piezoelectric pad 20 can be deformed directly by the input component. As FIG. 4 shows, an input component 110 includes an actuating end 111 while in the second embodiment, the input circuit board 13 is alternately disposed between the input component 110 and the piezoelectric pad 20. In other words, the actuating end 111 of the input component 110 passes through an opening of the input circuit board 13 and contacts the piezoelectric pad 20. When the input component 110 is pressed to move, the actuating end 111 deforms the piezoelectric pad 20 that generates the piezoelectric voltage then.

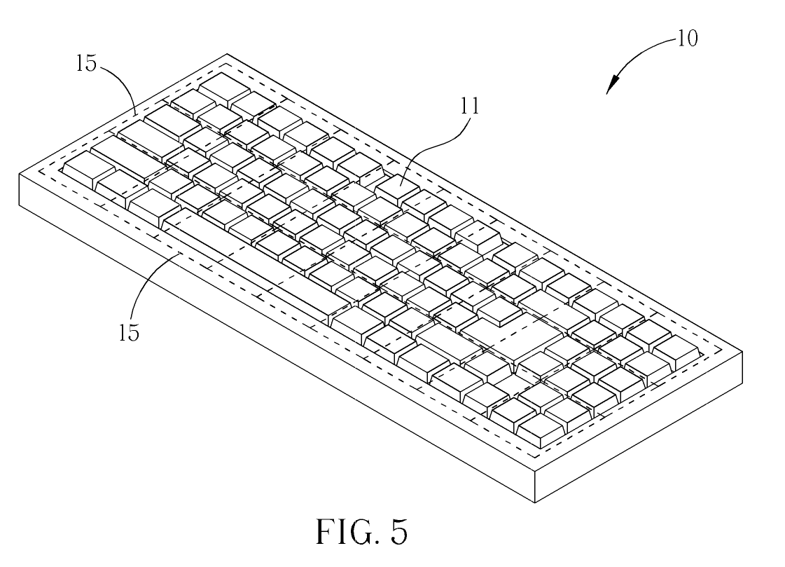

Additionally, in FIG. 2 and FIG. 4 of the embodiment of the present invention, one piezoelectric pad 20 inside the keyboard may correspond to two or more input components 11 (or input components 110) at the same time. When one of the input components 11, which correspond to a same piezoelectric pad 20, is pressed, the very piezoelectric pad 20 is deformed anyway and generates the piezoelectric voltage accordingly. FIG. 5 further shows that the plurality of input components 11 of the input device 10 can also be grouped into several input sets 15, while the plurality of piezoelectric pads 20, disposed under the input components 11 and invisible in FIG. 5, has one-to-one corresponding relation with each input set 15. These piezoelectric pads 20 have electrical connections with the power storage device 40 in serial, parallel, or composition of serial and parallel ways and form a recharging circuit. With such recharging circuit, users' repetitive clicking or pressing the input components 11 of the input device 10 can press and deform the corresponding piezoelectric pads 20, simultaneously or respectively, to continuously generate the piezoelectric voltages, to charge the power storage device 40. Power shortage of any electronic device can be effectively solved.

One or more piezoelectric pads are disposed into a keyboard and electrically connecting to a rechargeable battery of an electronic device or a portable electronic device. When one button of the keyboard is pressed, the movement of the button pushes and deforms the corresponding piezoelectric pad to generate a piezoelectric voltage for charging the battery. The electronic device or the portable electronic device can deal with power shortage during usage with the feature of transforming mechanical power into electrical power by using piezoelectric pads in the keyboard.

Those skilled in the art will readily observe that numerous modifications and alterations of the device and method may be made while retaining the teachings of the invention.

What is claimed is:

1. An input module, comprising:
a button;
an input circuit board;
a piezoelectric pad disposed between the button and the input circuit board wherein a piezoelectric voltage is generated when the piezoelectric pad is deformed by the button moving toward the input circuit board; and
a power storage device electrically connecting to the piezoelectric pad.

2. The input module of claim 1, further comprising a contact disposed between the button and the piezoelectric pad for being pushed by the button to deform the piezoelectric pad when the button moves toward the input circuit board.

3. The input module of claim 2, wherein the contact is made of resilient material.

4. The input module of claim 1, wherein the button comprises an actuating end wherein the actuating end pushes to deform the piezoelectric pad when the button moves toward the input circuit board.

5. The input module of claim 1, further comprising at least two buttons capable of moving toward the input circuit board respectively, the piezoelectric pad disposed on the path where the two buttons move toward the input circuit board respectively, the piezoelectric pad deforming to generate the piezoelectric voltage when one of the two buttons move toward the input circuit board.

6. The input module of claim 1, further comprising a plurality of buttons and a plurality of piezoelectric pads, each of the piezoelectric pads corresponding to one of a plurality of input sets that are composed by the plurality of buttons and is deformed when one button of the corresponding input set moves toward the input circuit board, the plurality of piezoelectric pads electrically connecting in parallel with one another and connecting to the power storage device.

7. The input module of claim 1, wherein the input circuit board generates electronic signals based on the movement of the button.

8. The input module of claim 1, wherein the input module is a keyboard.

9. The input module of claim 1, wherein the power storage device is a rechargeable battery.

10. The input module of claim 1, wherein the power storage device is electrically connected to a portable device.

11. The input module of claim 10, wherein the portable device is a notebook, a netbook, a mobile phone, or a Smartphone.

12. A portable electronic device, comprising:
a power storage device for storing and supplying power; and
an input module electrically connecting to the power storage device, the input module comprising:
a button;
an input circuit board; and
a piezoelectric pad disposed between the button and the input circuit board wherein a piezoelectric voltage is generated when the piezoelectric pad is deformed by the button moving toward the input circuit board;
wherein the power storage device electrically connects to the piezoelectric pad.

13. The portable electronic device of claim 12, wherein the input module further comprises a contact disposed between the button and the piezoelectric pad for being pushed by the button to deform the piezoelectric pad when the button moves toward the input circuit board.

14. The portable electronic device of claim 13, wherein the contact is made of resilient material.

15. The portable electronic device of claim 12, wherein the button comprises an actuating end wherein the actuating end pushes to deform the piezoelectric pad when the button moves toward the input circuit board.

16. The portable electronic device of claim 12, wherein the input module comprises at least two buttons capable of moving toward the input circuit board respectively, the piezoelectric pad is disposed on the path where the two buttons move toward the input circuit board respectively, and the piezoelectric pad is deformed to generate the piezoelectric voltage when one of the two buttons move toward the input circuit board.

17. The portable electronic device of claim 12, wherein the input module further comprises a plurality of buttons and a plurality of piezoelectric pads, each of the piezoelectric pads is corresponding to one of a plurality of input sets that are composed by the plurality of buttons and is deformed when one button of the corresponding input set moves toward the input circuit board, and the plurality of piezoelectric pads is electrically connecting in parallel with one another and connecting to the power storage device.

18. The portable electronic device of claim 12, wherein the input circuit board generates electronic signals based on the movement of the button.

19. The portable electronic device of claim 12, wherein the input module is a keyboard.

20. The portable electronic device of claim 12, wherein the power storage device is a rechargeable battery.

21. The portable electronic device of claim 12, wherein the portable electronic device is a notebook, a netbook, a mobile phone, or a Smartphone.
